(19) United States
(12) Patent Application Publication
(10) Pub. No.: US 2012/0153184 A1
(43) Pub. Date: Jun. 21, 2012

(54) LUMINESCENT PHOSPHOR-CONTAINING MATERIALS, AND METHODS FOR THEIR PRODUCTION AND USE IN AUTHENTICATING ARTICLES

(75) Inventor: James Kane, Lawrenceville, NJ (US)

(73) Assignee: HONEYWELL INTERNATIONAL INC., Morristown, NJ (US)

(21) Appl. No.: 13/308,268

(22) Filed: Nov. 30, 2011

Related U.S. Application Data
(60) Provisional application No. 61/425,408, filed on Dec. 21, 2010.

(51) Int. Cl. G01N 21/64; C09K 11/79; C09K 11/77

(52) U.S. Cl. 250/458.1; 252/301.4 R; 252/301.4 F; 252/301.36

(57) ABSTRACT

Embodiments of luminescent phosphor-containing materials include a medium and particles of a phosphor compound dispersed in the medium. The phosphor compound includes a host lattice comprising at least one alkaline earth element, manganese, and europium (e.g., divalent manganese and divalent europium). Embodiments of methods for producing such a phosphor-containing material include preparing a phosphor compound that includes the phosphor compound particles, and dispersing the particles in the medium to produce the phosphor-containing material. The material may then be incorporated into an article. Embodiments of a method for identifying a phosphor-containing material incorporated with an article include exposing a portion of the article to exciting radiation (e.g., light produced by a blue diode), and determining whether a detected emission produced as a result of the exciting radiation indicates a manganese emission following a europium absorption for at least a first time period after termination of the exposing step.

### RELATED APPLICATION

This application claims priority to co-pending, U.S. Provisional Application Ser. No. 61/425,408, filed on Dec. 13, 2010.

### TECHNICAL FIELD

The present invention generally relates to radiation emitting materials, articles including such materials, and methods for their production and use and, more particularly relates to luminescent phosphor-containing materials, articles including such materials as authentication features, and methods for their production and use.

### BACKGROUND

A luminescent phosphor compound is a compound that is capable of emitting detectable quantities of radiation in the infrared, visible, and/or ultraviolet spectrums upon excitation of the compound by an external energy source. A typical luminescent phosphor compound includes at least a host crystal lattice, an emitting ion (e.g., an ion of a rare earth metal), and in some cases, an absorbing ion (e.g., an ion of the same rare earth metal or a different rare earth metal that can transfer the energy to the emitting rare earth metal). The production of radiation by a phosphor compound is accomplished by direct absorption of excitation energy by the emitting ion and/or transfer of energy to the emitting ion (e.g., from the host crystal lattice and/or the absorbing ion), and subsequent radiation of the absorbed and/or transferred energy by the emitting ion.

The most common applications for luminescent phosphor compounds include cathode ray tube (CRT) screens and fluorescent lamps. In CRTs and fluorescent lamps, one or more phosphor compounds may be continually excited by an energy source when it is desired to cause the phosphor compound to produce visible light. Different emitting ions may produce light of different wavelengths, and therefore the selection of a phosphor compound (or multiple phosphor compounds) for a particular device typically is made based on the desired wavelength (or wavelengths) of light to be produced by the device. Because of the unique light-emitting properties of phosphor compounds, developers strive to determine new applications for such phosphor compounds.

### BRIEF SUMMARY

An embodiment of a luminescent phosphor-containing material includes a medium and particles of a phosphor compound dispersed in the medium. The phosphor compound has a host lattice including atoms of one or more alkaline earth elements, some of which have been replaced in the host lattice by manganese and europium.

An embodiment of a method for producing an article that includes a phosphor-containing material includes preparing a phosphor compound having a host lattice that includes atoms of one or more alkaline earth elements, some of which have been replaced in the host lattice by manganese and europium, and dispersing the phosphor compound in a medium to produce the phosphor-containing material.

An embodiment of an article includes a medium and a phosphor compound having a host lattice that includes atoms of one or more alkaline earth elements, some of which have been replaced in the host lattice by manganese and europium.

An embodiment of a method for identifying a phosphor-containing material incorporated on or within an article includes the steps of exposing a portion of the article to exciting radiation (e.g., light produced by a blue diode), and determining whether a detected emission produced by the portion as a result of the exciting radiation indicates a manganese emission following a europium absorption for at least a first time period after termination of the exposing step.

### BRIEF DESCRIPTION OF THE DRAWINGS

Embodiments of the present invention will hereinafter be described in conjunction with the following drawing figures, wherein like numerals denote like elements, and wherein:

FIG. 1 depicts a crystal structure of a phosphor compound, according to various example embodiments;

FIG. 2 is a graph illustrating the spectral characteristics of emitted radiation produced by europium and manganese in a phosphor compound, according to an example embodiment;

FIG. 3 is a graph illustrating the emission intensity decay characteristics for emitted radiation produced by europium and manganese in a phosphor compound, according to an example embodiment;

FIG. 4 is a flowchart of a method for producing a phosphor-containing material and/or an article, in accordance with an example embodiment;

FIG. 5 depicts a manual system for authenticating an article, in accordance with an example embodiment;

FIG. 6 is a flowchart of a manual method for performing authentication of an article that may include a phosphor compound, in accordance with an example embodiment;

FIG. 7 depicts an automatic system for authenticating an article, in accordance with an example embodiment;

FIG. 8 is a flowchart of an automatic method for performing authentication of an article that may include a phosphor compound, in accordance with an example embodiment;

FIG. 9 depicts a cross-sectional view of a phosphor-containing material, according to an example embodiment; and

FIG. 10 depicts a cross-sectional view of an article with a phosphor-containing, printed authentication feature, according to an example embodiment.

### DETAILED DESCRIPTION

The following detailed description of various embodiments of the invention is merely exemplary in nature and is not intended to limit the inventive subject matter or the application and uses of the inventive subject matter. Furthermore, there is no intention to be bound by any theory presented in the preceding background or the following detailed description.

Luminescent phosphor-containing materials (i.e., materials containing phosphor compounds), articles incorporating such materials, and methods of their manufacture and use are described herein. The below-described phosphor-containing materials may be used for a variety of applications including, but not limited to, incorporation of such phosphor-containing materials into articles to enhance article authentication efforts. Embodiments of phosphor compounds and phosphor-containing materials, described below, each include a phosphor host lattice that includes atoms of one or more alkaline earth elements, some of which have been replaced in the host lattice by manganese and europium. When one of these phosphor compounds is exposed to exciting radiation (e.g., light produced by a blue diode emitting exciting radiation at a wavelength in a range of about 430 to about 470 nanometers), the europium and manganese both produce emitted radiation. More particularly, the europium has an emission in the blue portion of the electromagnetic spectrum, and the manganese has an emission in the red portion of the electromagnetic spectrum. However, only the emitted radiation from the manganese has a sufficiently long persistence to be observable by the naked eye when the excitation source is removed.

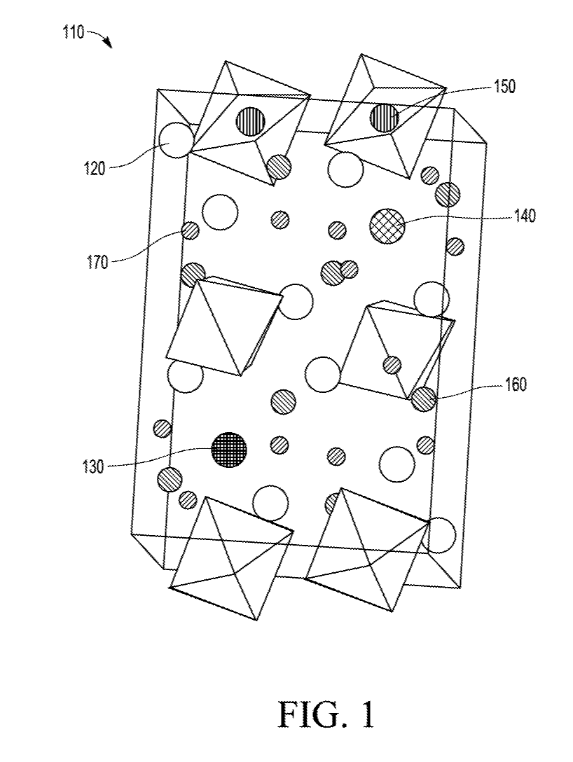

FIG. 1 depicts a crystal structure of a phosphor compound, according to various example embodiments. The example structure is provided by way of example only, and not by way of limitation. In other embodiments, the crystal structure may be different. Either way, the phosphor compound includes a phosphor host lattice material 110 within which at least one absorbing ion (e.g., europium 140) and at least one emitting ion (e.g., manganese 130 and europium 140) have been incorporated. More particularly, the phosphor host lattice material 110 includes a material (e.g., one or more alkaline earth elements 120) that has been partially replaced in the host lattice with manganese 130 and europium 140, in an embodiment. In an embodiment, both the manganese 130 and the europium 140 are divalent. In addition to the alkaline earth element(s) 120, the phosphor host lattice material 110 also includes other materials (e.g., magnesium (Mg) 150, silicon (Si) 160, and elemental oxygen (O) 170).

In a particular embodiment, the phosphor host lattice material 110 has the following empirical formula:

Me₃MgSi₂O₈,

where Me is an alkaline earth element (e.g., calcium (Ca), strontium (Sr), barium (Ba) or any combination thereof) that is doubly activated with manganese 130 and europium 140. In a particular embodiment, the host lattice material 110 is merwinite (Ca₃MgSi₂O₈), where Me is calcium. In another embodiment, when Me is barium, the host lattice material 110 formula is Ba₃MgSi₂O₈. The host lattice 110 is a crystal lattice into which different chemical constituents (e.g., the manganese 130 and europium 140) may substitute. For instance, in one embodiment of the phosphor compound, the alkaline earth element is barium, which is partially replaced by europium (0.04 of the stoichiometry) and manganese (0.1 of the stoichiometry) to form Ba_{2.86}Eu_{0.04}Mn_{0.1}MgSi₂O₈. Other embodiments may include various ratios of the alkaline earth element, europium, and manganese. In various embodiments, the host crystal lattice material 110 may be a material selected from a group consisting of a silicate and a pyrophosphate (e.g., Me₃MgP₂O₇), although other host lattice materials alternatively may be used.

According to an embodiment, the europium 140 functions as an absorbing ion, and both the europium 140 and the manganese 130 function as emitting ions. More particularly, the europium 140 absorbs exciting radiation within an appropriate absorption band (e.g., in a range of about 430 to about 475 nanometers), and transfers some of the absorbed energy to the manganese 130. The manganese 130 and europium 140 each may then produce emitted radiation at appropriate wavelengths. In an embodiment, the total concentration of manganese 130 and europium 140 substituted into the host crystal lattice material 110 is sufficient to cause the phosphor compound to produce an observable and/or detectable emission after being appropriately subjected to exciting radiation.

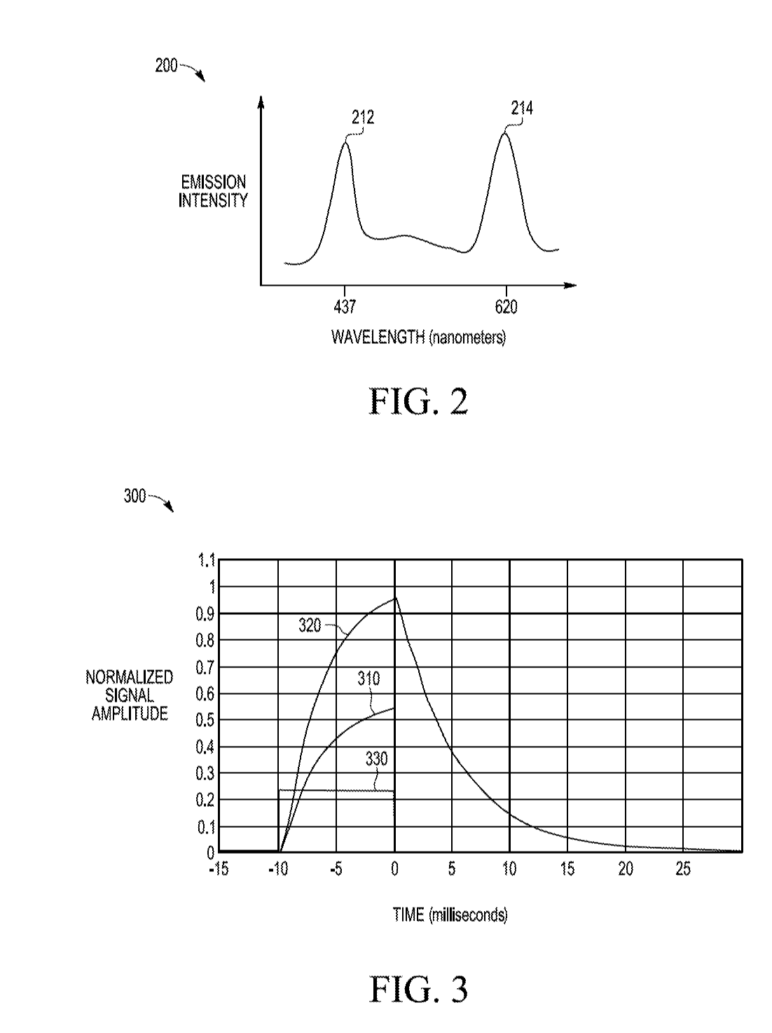

FIG. 2 is a graph 200 illustrating the spectral characteristics of emitted radiation produced by europium and manganese in a phosphor compound, according to an example embodiment. When the phosphor compound is exposed to exciting radiation, the energy absorbed by or transferred to the emitting ion(s) decays rapidly (usually non-radiatively) from the absorption resonance level to a storage level. From the storage level, spontaneous photon emission may occur at wavelengths determined by the storage level and a lower energy level. Because the wavelengths of emitted radiation are different for europium and manganese, the spectral characteristics of the emitted radiation for the phosphor compound includes at least two peaks 212, 214, where peak 212 corresponds to the europium emission at about 437 nanometers (corresponding to an emission within the blue portion of the electromagnetic spectrum), and peak 214 corresponds to the manganese emission at about 620 nanometers (corresponding to an emission within the red portion of the electromagnetic spectrum). More specifically, according to an embodiment, a phosphor compound produces emitted radiation having relatively high intensities at wavelengths centered at about 437 nanometers and about 620 nanometers, when the phosphor compound is exposed to appropriate exciting radiation (e.g., exciting radiation having a wavelength in a range of about 430 to about 475 nanometers).

Upon removal or discontinuation of the exciting radiation, the intensities of the europium and manganese emissions may be observed to decay over time, and the rate of decay for each of the manganese 130 and the europium 140 can be characterized by a decay time constant. For example, for a simple exponential decay in emission intensity, the decay time constant can be represented by the constant τ in the equation:

I(t)=I₀e^{-t/τ}, (Equation 1)

where t denotes time, I denotes the emission intensity at time t, and I₀ denotes the emission intensity at t=0 (e.g., t=0 may correspond to the instant when the provision of exciting radiation is discontinued). Although the emission intensity for some phosphor compounds may decay according to the above, simple exponential formula, the emission intensity for other phosphor compounds may be affected by multiple exponential decays (e.g., when multiple mechanisms affecting the decay are present). When an emission is no longer perceptible to the human eye, the emission is considered to have “substantially decayed.” In quantifiable terms, an emission may be considered to have “substantially decayed” when the emission has an intensity (or integrated intensity) of less than about 10 to 20 percent of a maximum intensity within a particular emission band (e.g., an emission band encompassing the first or second wavelength).

FIG. 3 is a graph illustrating the emission intensity decay characteristics for emitted radiation produced by europium and manganese in a phosphor compound (e.g., phosphor compound 100, FIG. 1), according to an example embodiment. More particularly, trace 310 represents the decay characteristics for europium, and trace 320 represents the decay characteristics for manganese. Trace 330 represents temporal characteristics of an exciting radiation pulse (i.e., each phosphor compound is exposed to the exciting radiation at t=−10 milliseconds, and the exciting radiation is discontinued at t=0). As discussed previously, the exciting radiation may be provided by a blue diode, although the exciting radiation may be provided by a different radiation source, as well (e.g., an ultraviolet diode or other excitation source).

As traces 310, 320 indicate, the emitted radiation from the manganese has a relatively long persistence (i.e., a relatively long period of time from discontinuation of the exciting radiation until the manganese emission has substantially decayed) when compared with the persistence of the emitted radiation from the europium. For example, the europium emission may substantially decay within a time period in the range of about a microsecond, whereas the time period for the manganese emission to substantially decay may be within a range of about 20 milliseconds or more. In other embodiments (e.g., when the europium and manganese are in other host lattices), it may take longer or shorter times for the manganese emission to substantially decay. Typically, the time for the europium emission to substantially decay is extremely short (e.g., on the order of a microsecond), regardless of the host lattice.

Embodiments of phosphor compounds discussed above may be combined with other materials to produce phosphor-containing materials, and these phosphor-containing materials may be further incorporated into various types of articles. For example, as will be discussed in more detail below, embodiments of phosphor compounds discussed above may be combined with ink or another printable material to produce a printable phosphor-containing material. Alternatively, as will also be discussed in more detail below, embodiments of phosphor compounds discussed above may be dispersed within various “solidifiable” mediums (e.g., liquids, slurries, and so on) to produce phosphor-containing materials that may be shaped, cured and/or formed into various articles or article components.

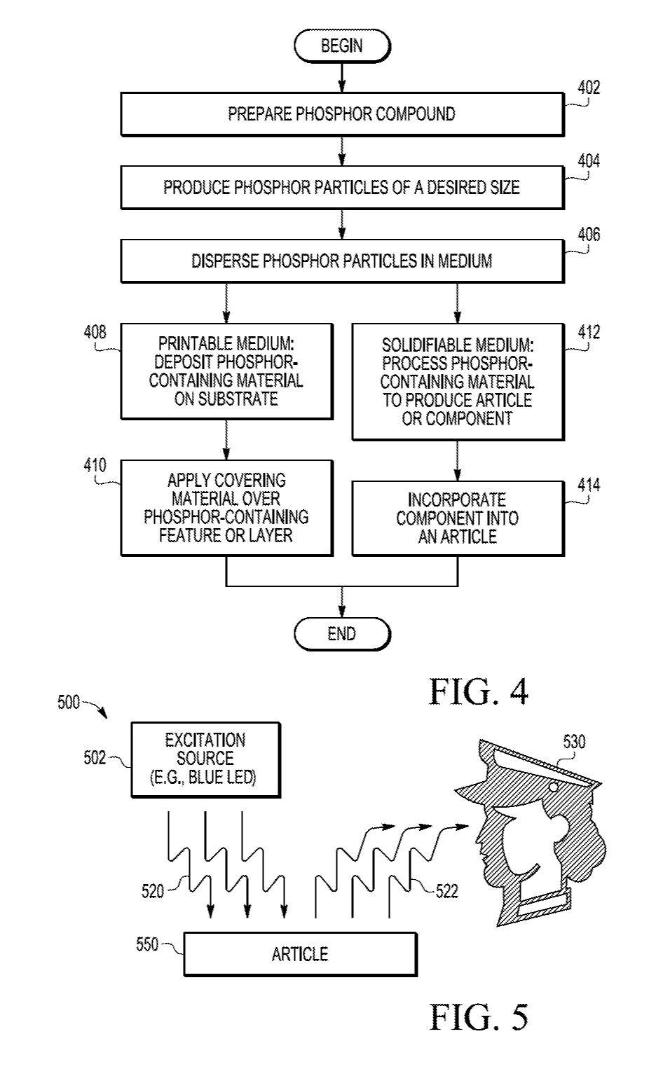

FIG. 4 is a flowchart of a method for producing a phosphor-containing material (e.g., a material that includes phosphor compound 100, FIG. 1) and an article that includes a phosphor-containing material, in accordance with an example embodiment. The method begins, in block 402, by preparing a phosphor compound. Creation of a phosphor compound, according to an embodiment, includes preparing a phosphor host lattice material (e.g., host lattice material 110, FIG. 1) having a material that is doubly activated with manganese and europium to form a preliminary phosphor compound. Generally, a phosphor compound in accordance with an embodiment may be created using any of a number of conventional processes that are known to those of skill in the art.

In some cases, the preliminary phosphor compound may be prepared using solid state chemistry. For example, when the phosphor compound is an oxide phosphor, this may include combining correct proportions of various oxides and other materials with oxides of an absorbing ion (e.g., europium) and an emitting ion (e.g., manganese and europium). These oxides are mixed and fired for a prescribed time. In other cases, solution chemistry techniques may be used, in which the various materials are dissolved, subsequently precipitated, and subsequently fired. Depending on the particular processes used to create the compound, other materials may be included in the combination of the host crystal lattice material, absorbing ion(s), and emitting ion(s) in forming the preliminary phosphor compound. For example, various fluxing agents and other pre-cursors may be included within the preliminary phosphor compound.

The preliminary phosphor compound may be post-processed, in an embodiment. Post-processing may include a number of processing steps that correspond with the particular process used to complete the creation of the phosphor compound. For example, post-processing may include performing any one or more of the following processes to the preliminary phosphor compound: annealing; suspension; precursor removal (e.g., to remove fluxing agents); sedimentation; and sonication. In a particular embodiment, post-processing includes firing the preliminary phosphor compound in a reducing atmosphere (e.g., firing in a hydrogen or carbon monoxide atmosphere) to ensure that the europium is in a divalent state. Firing in an oxidizing atmosphere would result in the production of trivalent europium, which would render the preliminary phosphor compound unsuitable for various applications. More particularly, trivalent europium has no absorption band in the blue portion of the electromangentic spectrum. Accordingly, in a phosphor compound in which the europium is utilized as the absorbing ion, the phosphor compound would be incapable of being excited with an excitation source that produces light in the blue portion of the electromagnetic spectrum (e.g., light produced by a blue light emitting diode).

In an embodiment, for example, the phosphor compound is Ba_{2.86}Eu_{0.04}Mn_{0.1}MgSi₂O₈ (e.g., a barium magnesium silicate phosphor in which the barium has been partially replaced in the host lattice with manganese and europium), and preparation of the phosphor compound may include thoroughly mixing quantities of barium carbonate, silica, and magnesium hydroxy carbonate powder corresponding to the Ba_{2.86}MgSi₂O₈ stoichiometry. Europium oxide and manganese carbonate corresponding to 0.04 and 0.1, respectively, of the stoichiometry are dissolved in dilute nitric acid and slurried into the Ba_{2.86}MgSi₂O₈ powder mixture. A small quantity of ammonium chloride corresponding to about 1.0 mole percent of the mixture may be added, in an embodiment, to provide a chloride flux. The flux may have the effect of enhancing the luminescent efficiency of the phosphor, and may reduce the required firing time. In an embodiment, the mixture may be fired in an alumina crucible in a reducing atmosphere for about 3 hours at about 1100 degrees to produce the preliminary phosphor compound.

In block 404, the phosphor compound optionally may be further processed to produce phosphor particles with a desired particle size. Processing may include, for example, grinding or milling the phosphor compound to reduce the size of its particles. In addition or alternatively, particles of the desired size may be filtered out of the phosphor compound. According to an embodiment, the phosphor compound is processed to produce phosphor particles that produce visible emissions in ambient light, when excited by appropriate exciting radiation. For example, the phosphor compound may be processed to produce phosphor particles in a range from about 1 micron to about 20 microns. In another embodiment, the phosphor compound may be processed to produce phosphor particles in a range from about 5 microns to about 10 microns. In other embodiments, the phosphor compound may be processed to produce phosphor particles that are smaller or larger than the above-given ranges.

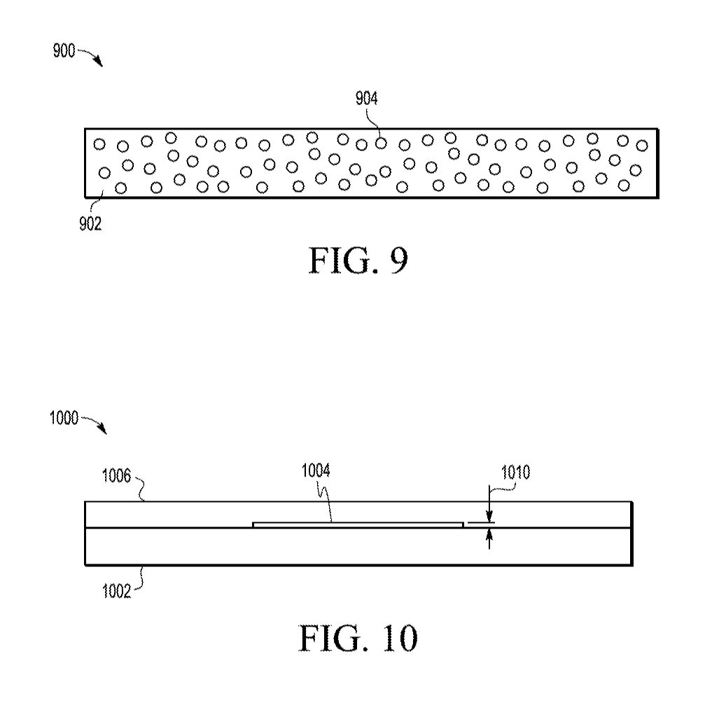

In block 406, the phosphor particles (e.g., particles 904, FIG. 9) are dispersed in a medium (e.g., medium 902, FIG. 9). In an embodiment, the medium may be a printable medium. For example, a printable medium may be an ink (e.g., plastisol, a water-based ink, or another ink) or another printable material (e.g., a glue, an ink additive, and so on). As used herein, a “printable medium” means any liquid, gel or otherwise viscous composition that is capable of being printed onto a substrate using any of a variety of printing or other material layer deposition technologies. In another embodiment, the medium may be a solidifiable medium (e.g., a polymer, an uncured medium, a gel, a slurry, or a medium at a temperature above its melting, solid phase transition, or glass transition temperature). As used herein, a “solidifiable medium” means a medium in a liquid, viscous or amorphous form in which it is possible to mix or otherwise combine phosphor particles. For example, in various embodiments, the solidifiable medium may include a polymer, a plastic, glass, a ceramic, a metal, and a paper pulp slurry, to name a few.

At this point, the phosphor-containing material may be adequate for some intended purpose. Alternatively, the phosphor-containing material may be incorporated into an article. The method of incorporation of the phosphor-containing material produced in block 406 into an article depends on the characteristics of the medium within which the phosphor particles are dispersed and the type of article. For example, when the phosphor-containing material includes phosphor particles dispersed in a printable medium, the phosphor-containing material may be printed or otherwise deposited onto a substrate (e.g., substrate 1002, FIG. 10), in block 408, to produce a deposited layer or phosphor-containing feature (e.g., feature 1004, FIG. 10). The printable phosphor-containing material may be deposited on any of a variety of different types of substrates, including but not limited to paper, a polymer, plastic, glass, a metal, a textile, a ceramic, wood, and a fiber, to name a few.

According to an embodiment, a printable phosphor-containing material is printed onto a substrate using a screen printing process, although other printing or material layer deposition processes may be used, as well (e.g., intaglio printing, offset printing, spraying, painting, and so on). Using a screen printing process, the printable phosphor-containing material is pressed through a woven mesh that supports an ink-blocking stencil. The attached stencil forms open areas of mesh that facilitate transfer of the printable phosphor-containing material onto the underlying substrate. The use of screen printing, according to an embodiment, may be particularly advantageous in that the process may reliably produce good results even when the phosphor particles are relatively large (and thus may not be suitable for other printing processes). In addition, the screen printing process enables a relatively thick layer of the phosphor-containing material to be deposited on the substrate, when compared with other printing processes. Accordingly, the screen printing process may result in a deposited feature that produces relatively high intensity emissions (e.g., emissions that readily may be observable in ambient light). Although a single layer of phosphor-containing material may be deposited to create a deposited layer or phosphor-containing feature with a desired thickness, in an embodiment, multiple layers alternatively may be deposited to produce the desired thickness, in other embodiments.

In block 410, a covering material (e.g., a protective material such as covering material 1006, FIG. 10) optionally may be applied over the deposited layer or phosphor-containing feature. Along with providing other features, the covering material may protect the deposited layer or phosphor-containing feature from thinning or other damage that otherwise may be incurred from exposure of the feature to environmental elements and/or physical contact with the feature (e.g., rubbing, touching, folding or striking the feature).

Alternatively, and as mentioned above, the phosphor-containing material may include phosphor particles dispersed in a solidifiable medium. In such a case, the phosphor-containing material may further processed, in block 412, to produce a solid, phosphor-containing material. The solid, phosphor-containing material may take the form of a film, a sheet, or a mass, in various embodiments. Depending on the desired form, further processing of the phosphor-containing material may include cooling (vitrification), curing, pressing, molding, drying, heating, firing, or other processing steps that cause the phosphor-containing material to transition into a solid configuration. The processing steps may result in a completed phosphor-containing article, or a phosphor-containing component of an article.

When the processing steps result in a phosphor-containing component, the component optionally may be incorporated with other components of the article to produce a phosphor-containing article, in block 414. For example, the phosphor-containing component may be adhered, attached, laminated to, inserted into, or otherwise physically coupled with one or more other article components.

When a phosphor compound of an embodiment is incorporated into an article, the characteristics of the phosphor compound may be exploited for any of a number of purposes, including but not limited to article authentication and article tracking, for example. Although article authentication is discussed in detail below, the use of a phosphor compound of an embodiment is not limited only to article authentication.

The unique temporal and spectral properties of a phosphor compound of an embodiment make the phosphor compound well suited for use in authenticating or identifying articles of particular value or importance. For example, an embodiment of a phosphor compound may be incorporated into articles such as, but not limited to, an identification card, a driver's license, a passport, identity papers, a banknote, a check, a document, a paper, a stock certificate, a packaging component, a credit card, a bank card, a label, a seal, a postage stamp, a liquid, and a biological sample, to name a few. When an embodiment of a phosphor compound has been incorporated into an article, the temporal and/or spectral properties of the phosphor compound may be analyzed to detect forgeries or counterfeit copies of such articles, and/or to track and identify the articles.

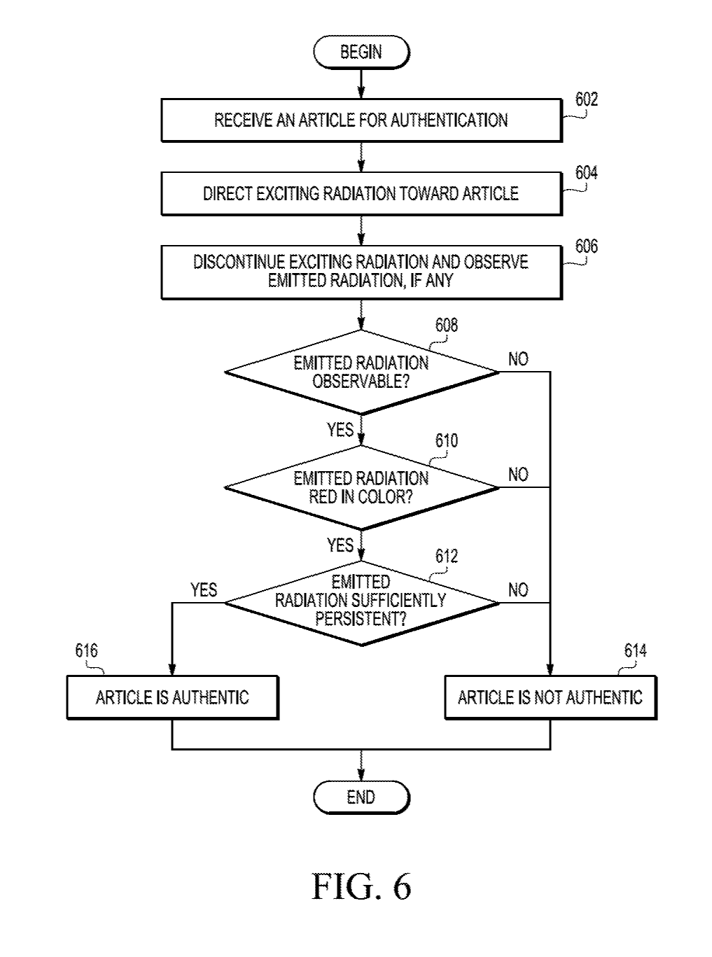

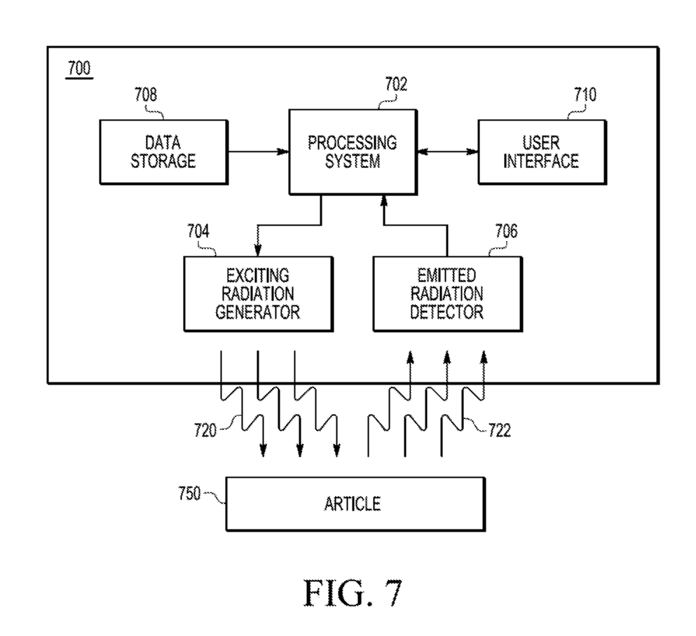

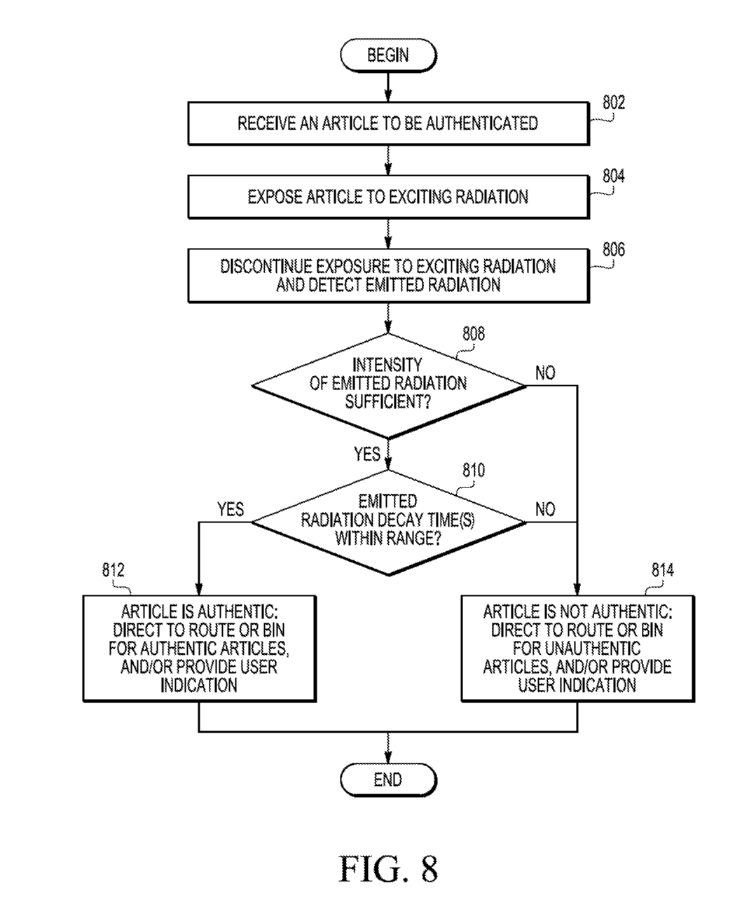

More particularly, an article producer (including commercial manufacturers, government entities, and individuals) may incorporate an embodiment of a phosphor compound into its “authentic” articles. Subsequently, manual techniques and/or specially designed authentication equipment may be employed to determine whether an article that is purported to originate from the producer actually does originate from the producer. A manual system and method for determining the authenticity of an article is discussed in more detail, below, in conjunction with FIGS. 5 and 6. An automatic system and method for determining the authenticity of an article is discussed in more detail, later, in conjunction with FIGS. 7 and 8.

FIG. 5 depicts a manual system 500 for authenticating an article 550, in accordance with an example embodiment. FIG. 5 should be viewed in conjunction with FIG. 6, which is a flowchart of a manual method for performing authentication of an article that may include a phosphor compound, in accordance with an example embodiment. Essentially, a manual system 500 for authenticating an article 550 includes an excitation source 502 and a human observer 530. According to an embodiment, the excitation source 502 includes a blue light emitting diode (LED) or other light source, which is capable of emitting exciting radiation having wavelengths in the absorption band of europium (e.g., europium 140, FIG. 1) within a phosphor compound. For example, the excitation source 502 may be capable of emitting exciting radiation having wavelengths in a range from about 430 to about 475 nanometers (i.e., a blue portion of the electromagnetic spectrum), in an embodiment. The excitation source 502 may, for example, be incorporated into a small, portable housing (e.g., a pen-shaped housing), making it convenient for use by the human observer 530. In addition, a switch (not illustrated) may be coupled with the excitation source 502, which enables the human observer 530 to selectively connect or disconnect the excitation source 502 with/from power (e.g., a battery or line power), in order to turn the excitation source 502 on or off.

Referring also to FIG. 6, a manual method for authenticating an article (e.g., article 550) begins, in block 602, when the article 550 is received by the human observer 530 for authentication. The human observer 530 brings the excitation source 502 in proximity to or in contact with a surface of the article 550, and causes exciting radiation 520 to be directed toward the article, in block 604. For example, the human observer 530 may turn the excitation source 502 on, and either flood the surface of the article 550 with the exciting radiation 520 produced by the excitation source 502, or may bring the excitation source 502 into contact with (or just above) a point on the surface of the article 550, and turn the excitation source 502 on. In the latter case, the human observer 530 may either allow the excitation source 502 to remain in a stationary position, or may draw the excitation source 502 across the surface of the article 550.

In block 606, the exciting radiation is discontinued, and the human observer 530 may observe whether emitted radiation 522, if any is perceptible to the naked eye. The human observer 530 may then make a series of determinations in order to form an opinion of whether or not the article 550 is authentic. For example, a first determination may be made, in block 608, whether or not any or a sufficient intensity of emitted radiation 522 is observable. If not, this would indicate that a phosphor compound of an embodiment is not present in or on the article 550 or that an insufficient quantity of the phosphor compound is present in or on the article 550 to indicate authenticity of the article 550. Accordingly, the human observer 530 may determine, in block 614 that the article 550 is not authentic, and the method may end.

When, however, the human observer 530 determines that a sufficient intensity of emitted radiation 522 is present, the human observer 530 may make a further determination, in block 610, of whether the emitted radiation 522 has a color that is characteristic of a manganese emission (e.g., a red color, or an emission in the red portion of the electromagnetic spectrum). As discussed previously, although the europium also may emit radiation (e.g., a blue colored emission), the time for the europium emission to substantially decay may be so short (e.g., on the order of about a microsecond) that the europium emission may be unperceivable to the human observer 530 in the absence of continuous excitation. Conversely, the time for the manganese emission to substantially decay may be significantly longer (e.g., on the order of 20 milliseconds or more), and accordingly the manganese emission may be sufficiently persistent to be observable to the human observer 530. If the human observer 530 determines that the color of the emitted radiation 522 is not characteristic of a manganese emission (e.g., the color is not red), this would indicate that a phosphor compound, which is different from a phosphor compound of an embodiment, is present in or on the article 550. Accordingly, the human observer 530 may determine, in block 614 that the article 550 is not authentic, and the method may end.

When, however, the human observer 530 determines that the color of the emitted radiation 522 is characteristic of a manganese emission (e.g., a red color), the human observer 530 may make a further optional determination, in block 612, whether the emitted radiation 522 is sufficiently persistent. According to an embodiment, the phosphor compound produces an emitted radiation at an intensity that renders the emitted radiation visible to the naked eye for at least 20 milliseconds after discontinuation of exposure of the phosphor compound to the exciting radiation. With the relatively long period of time for the manganese emission to substantially decay, the emitted radiation 522 should appear to fade relatively slowly upon discontinuation of the exciting radiation 520. For example, if the surface of the article 550 was flooded with the exciting radiation 520 which was thereafter discontinued, an entirety of a surface of a phosphor-containing portion of the article 550 would produce the manganese emission, and the emission would gradually fade from the surface. Alternatively, if only a point on or above the surface of a phosphor-containing portion of the article 550 was exposed to the exciting radiation 520 and the exciting radiation 520 was thereafter discontinued, the manganese emission would appear and gradually fade from that point on the article 550. As yet another example, if the human observer 530 draws the excitation source 502 across or above a portion of the surface of the article corresponding to an area at which the phosphor compound is present, the human observer 530 may observe a red, comet-like tail following the path of the excitation source 502. In either instance, the human observer 530 may determine, in block 616, that the article 550 is authentic, and the method may end.

The above-described system and method may be particularly useful in situations in which a human (e.g., human observer 530) is tasked with determining the authenticity of articles in a rapid manner. As just a few examples, and not by way of limitation, the system and method may be useful for determining the authenticity of passports or other identification cards or papers (e.g., by security personnel at airports and other points of entry or departure), value documents, currency or credit cards (e.g., by clerks at banks or retail locations), driver's licenses (e.g., by police officers during traffic stops), and retail goods that are frequently subject to counterfeiting (e.g., clothing, handbags, books, shoes, and so on).

In other situations, benefits may be obtained by performing article authentication in a more rapid and automatic fashion (e.g., when authentic articles are being sorted from non-authentic articles by an automated system). Accordingly, embodiments also include systems and methods for performing automatic authentication of articles.

FIG. 7 depicts an automatic system 700 for authenticating an article 750, in accordance with an example embodiment. System 700 includes a processing system 702, an exciting radiation generator 704, an emitted radiation detector 706, data storage 708, and a user interface 710, according to an embodiment. Processing system 702 may include one or more processors and associated circuitry, which are configured to implement control and analysis processes (e.g., in the form of executable software algorithms) associated with authenticating an article (e.g., article 750). According to an embodiment, processing system 702 is configured to provide control signals to exciting radiation generator 704, which cause exciting radiation generator 704 to direct exciting radiation 720 toward article 750. In the control signals, processing system 702 may specify the timing (e.g., start time, stop time, and/or duration) of the provision of exciting radiation, and/or other parameters associated with the particular exciting radiation to be generated (e.g., intensities and/or other parameters). According to an embodiment, the bandwidth of the exciting radiation is within the range of the absorption band of europium (e.g., within a range of about 430 to about 475 nanometers or the blue portion of the electromagnetic spectrum). The various timing and/or radiation generation parameters may be retrieved from data storage 708, for example. Exciting radiation generator 704 may include, for example but not by way of limitation, one or more lasers, laser diodes, LED (e.g., blue LEDs), incandescent filaments, lamps, or other excitation sources.

In addition to controlling exciting radiation generator 704, processing system 702 is configured to provide control inputs to emitted radiation detector 706, which cause emitted radiation detector 706 to attempt to detect emitted radiation 722 produced by article 750 in response to having absorbed at least some of the exciting radiation 720. Emitted radiation detector 706 may include, for example but not by way of limitation, a spectral filter, one or more electro-optical sensors, photomultiplier tubes, avalanche photodiodes, photodiodes, charge-coupled devices, charge-injection devices, photographic films, or other detection devices. In a particular embodiment, the emitted radiation detector 706 includes a spectral filter positioned between the article 750 and a photodetector. The spectral filter may pass light only within a spectral band of interest (e.g., a manganese emission band), and rejects all other light. The photodetector has sensitivity within the spectral band of interest, and accordingly may detect light passing through the spectral filter that is within that spectral band. The emitted radiation detector 706 may digitize intensity values at one or more pre-selected intervals (e.g., starting at t=0, and then every 0.1 milliseconds thereafter, for several intervals). Emitted radiation detector 706 provides information to processing system 702 (e.g., the digitized intensity values), which enables the intensity and/or temporal properties of any detected radiation 722 to be characterized.

Processing system 702 is configured to analyze such information, upon its receipt, in order to determine whether or not the intensity and/or temporal properties of any detected radiation (e.g., the decay time constant and/or time for the emission to substantially decay) correspond to the intensity and/or temporal properties of a phosphor compound of an embodiment (i.e., a phosphor compound having sufficient quantities of at least a europium absorbing ion and a manganese emitting ion). For example, information characterizing the anticipated temporal properties and the emission intensities of a phosphor compound of an embodiment may be retrieved from data storage 708. According to various embodiments, the system 700 may be used to detect emissions within a single, relatively narrow frequency band (e.g., to detect emissions from manganese within the red portion of the electromagnetic spectrum), or the system 700 may be used to detect emissions within multiple frequency bands (e.g., to detect emissions characteristic of manganese and/or other emitting ions within multiple bands).

When the temporal properties and/or the emission intensity of detected radiation corresponds to the anticipated temporal properties and/or the emission intensity of an embodiment of a phosphor compound, processing system 702 may take some action associated with identifying article 750 as an authentic article. For example, processing system 702 may send a signal to user interface 710, which causes user interface 710 to produce a user-perceptible indication of authenticity (e.g., a displayed indicia, a light, a sound, and so on), and/or processing system 702 may cause a routing component (not illustrated) of system 700 to route article 750 toward a route or bin assigned for authentic articles. Alternatively, when insufficient radiation is detected or the temporal properties of detected radiation do not correspond to the anticipated authentication parameters of an embodiment of a phosphor compound, processing system 702 may take some action associated with identifying article 750 as an unauthentic article. For example, processing system 702 may send a signal to user interface 710, which causes user interface 710 to produce a user-perceptible indication of non-authenticity (e.g., a displayed indicia, a light, a sound, and so on), and/or processing system 702 may cause a routing component of system 700 (not illustrated) to route article 750 toward a route or bin assigned for non-authentic articles.

User interface 710 may include any of a number of components that may be manipulated by a user to provide inputs to system 700 (e.g., keyboards, buttons, touchscreens, and so on), or which may be controlled by processing system 702 to produce user-perceptible indicia (e.g., display screens, lights, speakers, and so on). The above-described process may be initiated in response to user inputs provided through the user's interaction with user interface 710, for example. Alternatively, the above-described process may be initiated automatically by the system 700, such as when the article 750 has been positioned in a location at which the excitation and detection processes may be performed.

FIG. 8 is a flowchart of an automatic method for performing authentication of an article that may include a phosphor compound, in accordance with an example embodiment. For example, embodiments of the method depicted in FIG. 8 may be performed by an authentication system (e.g., authentication system 700, FIG. 7). The method may begin, in block 802, when an article to be authenticated (e.g., article 750, FIG. 7) is received by the authentication system. For example, the article may be manually placed within an appropriate receptacle of the authentication system, or the article may automatically be routed into the receptacle (e.g., by a sorting or conveyor system).

In block 804, the article is exposed to exciting radiation (e.g., exciting radiation within the absorption band for europium). For example, the article may be moved to an excitation position (e.g., under an excitation window), and the processing system (e.g., processing system 702, FIG. 7) may send a control signal to an exciting radiation generator (e.g., exciting radiation generator 704, FIG. 7) that causes the exciting radiation generator to direct exciting radiation toward the article. Alternatively, the exciting radiation generator may continuously provide the exciting radiation or the exciting radiation may be modulated.

In block 806, provision of the exciting radiation to the article is discontinued. This may be accomplished either by turning the source of the exciting radiation off (e.g., in a system in which the article may remain stationary and the exciting radiation is pulsed), or by moving the article away from the area where the exciting radiation is being directed and to a detection position (e.g., under a detection window). The authentication system may then detect emitted radiation (e.g., within one or more bands) from the article (e.g., by emitted radiation detector 706, FIG. 7) at one or more detection intervals, which are measured from the time that direction of the exciting radiation toward the article was discontinued. According to an embodiment, the system is configured to detect emitted radiation in a range between about 620 nanometers and 750 nanometers (i.e., a red colored emission), although the system may be configured to detect emitted radiation having lower or higher wavelengths, as well.

Information characterizing the intensity and/or temporal behavior of detected, emitted radiation is then analyzed. In an embodiment, the system determines, in block 808, whether the intensity or integrated intensity of the emitted radiation is above a threshold intensity. When the intensity or integrated intensity of the emitted radiation is not above a threshold intensity, the system may identify the article as being “unauthentic,” and may take a corresponding action, in block 814. For example, the system may produce a user-perceptible indication of non-authenticity, and/or may cause a routing component of the system to route the article toward a route or bin assigned for unauthentic articles.

According to an embodiment, in addition to or in lieu of an intensity-based determination, the decay time constant of emitted radiation (and/or the time for an emission to substantially decay) may be determined and evaluated. More particularly, parameters associated with the decay characteristics of emitted radiation within one or more bands may be detected, and a determination is made, in block 810, whether the decay characteristic(s) are within specified ranges for the particular phosphor compound (e.g., whether any detected emission in the red portion of the electromagnetic spectrum substantially decays in a time period equal to or greater than about 20 milliseconds). In an embodiment, the decay characteristic(s) may be determined based on the detected intensities of the emitted radiation at multiple times (e.g., t=0, t=0.1 millisecond, and so on). Although the determinations of decay characteristic(s) within a single band may used as a basis for authenticating an article, in an embodiment, the determinations alternatively may be made by analyzing relative intensities of emitted radiation in multiple bands (e.g., analysis of the ratios of the intensities of emitted radiation in multiple bands), in other embodiments. Analysis using the relative intensities may be more desirable than an absolute intensity evaluation, because various factors, which may not be readily accountable for, may affect the accuracy of an absolute intensity reading. For example, the intensity of emitted radiation may be affected by soil and/or wear on the article or authentication feature, variations in the printing of authentication features, optical geometry, reflectivity of the substrate, light scattering within the substrate, size and shape of the article, substrate thickness versus penetration depth of the exciting radiation, and the power level of the excitation source, to name a few factors.

When the temporal characteristics (e.g., the decay characteristics) of the emitted radiation are within the specified ranges for the specific detection time (as determined in block 810), the system may identify the article as being “authentic,” and may take a corresponding action, in block 812. For example, the system may produce a user-perceptible indication of authenticity, and/or may cause a routing component of the system to route the article toward a route or bin assigned for authentic articles. Alternatively, when the temporal characteristics of the emitted radiation are not within specified ranges (as determined in block 810), the system may identify the article as being “unauthentic,” and may take a corresponding action, in block 814. For example, the system may produce a user-perceptible indication of non-authenticity, and/or may cause a routing component of the system to route the article toward a route or bin assigned for unauthentic articles. The method may then end.

FIG. 9 depicts a cross-sectional view of a phosphor-containing material 900, according to an example embodiment. As discussed previously, a phosphor-containing material 900 includes phosphor particles 904 dispersed in a medium 902. The phosphor particles 904 include a phosphor host lattice that includes a component that is doubly activated with manganese and europium, as discussed previously. In an embodiment, the phosphor particles 904 have particle sizes in a range from about 1 to about 20 microns, or more desirably in a range of about 5 to about 10 microns, although some or all of the phosphor particles 904 may be larger or smaller, as well. The phosphor particles 904 may be evenly dispersed through the medium 902, as shown in FIG. 9, or the phosphor particles 904 may be unevenly dispersed through the medium 902.

As indicated previously, the medium 902 may be any of a variety of liquids or solids. When the medium 902 is a solid, the phosphor-containing material 900 may be shaped in the form of a film, sheet, or mass. In cases in which the medium 902 initially is a liquid (e.g., when the phosphor particles 904 are dispersed therein), the liquid may subsequently be transitioned to a solid phase. Alternatively, the medium 902 may be retained in the liquid phase.

FIG. 10 depicts a cross-sectional view of an article 1000 with a phosphor-containing, printed authentication feature 1004, according to an example embodiment. In an embodiment, article 1000 includes a substrate 1002, a printed authentication feature 1004, and optionally a covering material 1006. In various embodiments, article 1000 may be any type of article selected from a group that includes, but is not limited to, an identification card, a driver's license, a passport, identity papers, a banknote, a check, a document, a paper, a stock certificate, a packaging component, a credit card, a bank card, a label, a seal, a textile, and a postage stamp.

Article 1000 includes a substrate 1002, which may be rigid or flexible, and which may be formed from one or more layers or components, in various embodiments. The variety of configurations of substrate 1002 are too numerous to mention, as the phosphor compounds of the various embodiments may be used in conjunction with a vast array of different types of articles. Therefore, although a simple, unitary substrate 1002 is illustrated in FIG. 10, it is to be understood that substrate 1002 may have any of a variety of different configurations. Substrate 1002 may be any of various types of substrates, and includes one or more materials selected from a group that includes, but is not limited to, paper, a polymer, plastic, glass, a metal, a textile, a ceramic, wood, and a fiber, to name a few.

Printed authentication feature 1004 includes one or more layers of a phosphor-containing material (e.g., phosphor-containing material 900, FIG. 9). In an embodiment, printed authentication feature 1004 has a thickness 1010 in a range of about one micron or more, although it may be desirable for printed authentication feature 1004 to have a thickness 1010 of at least about 10 microns, in another embodiment.

Covering material 1006 optionally may be applied over the printed authentication feature 1004. For example, covering material 1006 may include, but is not limited to, a laminate film, liquid laminate, resin, epoxy, varnish or other covering material may be applied over a portion of the surface of substrate 1002 on which the printed authentication feature 1004 is located. As mentioned previously, the covering material 1006 may protect the printed authentication feature 1004 from thinning or other damage that otherwise may be incurred from exposure to environmental elements and/or physical contact.

The above description of FIG. 10 discusses embodiments in which an authentication feature 1004 is printed on a surface of an article 1000. In other embodiments, a phosphor compound of an embodiment may be embedded within a substrate. For example but not by way of limitation, particles of a phosphor compound of an embodiment may be mixed into a base material (e.g., paper pulp, plastic base resin, and so on) for the substrate, and/or the substrate may be impregnated with a colloidal dispersion of a phosphor compound of an embodiment. Impregnation may be performed, for example, by a printing, dripping, or spraying process.

The various relative dimensions of the authentication feature 1004 may not be to scale in FIG. 10. In addition, although article 1000 is illustrated to include only one authentication feature 1004 on one surface of substrate 1002, another article may include multiple authentication features on one or more surfaces of the substrate 1002. In addition, although authentication feature 1004 is shown as a discrete feature, a printed authentication feature may be in the form of a layer, which may cover a significant portion or all of one or more surfaces of the substrate 1002, in other embodiments. In still other embodiments, an authentication feature may be embedded within the substrate 1002 (e.g., the authentication feature may be a security ribbon or other feature embedded within the substrate 1002).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A luminescent phosphor-containing material comprising:
a medium; and
particles of a phosphor compound dispersed in the medium, the phosphor compound having a host lattice comprising at least one alkaline earth element, manganese, and europium.

2. The luminescent phosphor-containing material of claim 1, wherein the at least one alkaline earth element is selected from a group consisting of calcium, strontium, barium, and mixtures thereof.

3. The luminescent phosphor-containing material of claim 1, wherein the phosphor compound has a formula Me₃MgSi₂O₈, wherein
Me is the at least one alkaline earth element, and Me is selected from a group consisting of calcium, strontium, barium, and a mixture thereof,
Mg is magnesium,
Si is silicon, and
O is oxygen.

4. The luminescent phosphor-containing material of claim 3, wherein the phosphor host lattice has a formula Ba_{2.86}Eu_{0.04}Mn_{0.1}MgSi₂O₈.

5. The luminescent phosphor-containing material of claim 1, wherein the manganese and the europium are divalent.

6. The luminescent phosphor-containing material of claim 1, wherein the medium is selected from a group consisting of an ink, a glue, an ink additive, a liquid, a gel, a polymer, a slurry, a plastic, a glass, a ceramic, a metal, a textile, a wood, a fiber and a paper.

7. The luminescent phosphor-containing material of claim 1, wherein the luminescent phosphor-containing material produces an emitted radiation at an intensity that renders the emitted radiation visible to the naked eye for at least 20 milliseconds after discontinuation of exposure of the luminescent phosphor-containing material to an exciting radiation.

8. The luminescent phosphor-containing material of claim 1, wherein the particles have a particle size in a range from about 1 micron to about 20 microns.

9. A method for producing an article that includes a phosphor-containing material, the method comprising the steps of:
preparing a phosphor compound having a host lattice comprising at least one alkaline earth element, manganese, and europium; and
dispersing the particles in a medium to produce the phosphor-containing material.

10. The method of claim 9, further comprising the step of:
processing the phosphor compound to produce the particles with a particle size in a range of from about 1 micron to about 20 microns.

11. An article comprising a luminescent phosphor-containing material comprising:
a medium; and
particles of a phosphor compound dispersed in the medium, the phosphor compound having a host lattice comprising at least one alkaline earth element, manganese, and europium.

12. The article of claim 11, wherein the article is selected from a group consisting of an identification card, a driver's license, a passport, identity papers, a banknote, a check, a document, a paper, a stock certificate, a packaging component, a credit card, a bank card, a label, a seal, a postage stamp, a textile, a liquid, and a biological sample.

13. A method for identifying a phosphor-containing material incorporated with an article, the method comprising the steps of:
exposing a portion of the article to exciting radiation; and
determining whether a detected emission produced by the portion as a result of the exciting radiation indicates a manganese emission following a europium absorption for at least a first time period after termination of the exposing step.

14. The method of claim 13, further comprising:
when the detected emission does not indicate the manganese emission for at least the first time period after termination of the exposing step, producing an indicia that the article is not authentic; and
when the detected emission indicates the manganese emission for at least the first time period after termination of the exposing step, producing an indicia that the article is authentic.

15. The method of claim 13, wherein the exposing step comprises exposing the portion of the article to light produced by a blue diode.
